(19) United States
(12) Patent Application Publication
(10) Pub. No.: US 2011/0168525 A1
(43) Pub. Date: Jul. 14, 2011

(54) PLANT FOR PREPARING BATCHES OF PRODUCTS, BOTTLES OR THE LIKE

(75) Inventors: Michael Vasse, Octeville-sur-mer (FR); Lionel Daniere, Octeville-sur-mer (FR); Yannick Langlois, Octeville-sur-mer (FR)

(73) Assignee: SIDEL PARTICIPATIONS, Octeville-sur-Mer (FR)

(21) Appl. No.: 13/119,618

(22) PCT Filed: Sep. 29, 2009
(86) PCT No.: PCT/FR2009/051840

§ 371 Date: Mar. 17, 2011

(30) Foreign Application Priority Data
Oct. 3, 2008 (FR) 08/56713

(51) Int. Cl. B65G 47/08; B65G 47/84

(52) U.S. Cl. 198/419.1

(57) ABSTRACT

The plant comprises: —an upstream conveyor (2), —a downstream conveyor (4), —a regulating device (7) comprising a system of retractable stops (13) which are inserted temporarily between two consecutive products in a single column, —and means for adjusting the speed of the different conveyors (2, 4), said plant additionally comprising means for adjusting the width of the passages of said adjusting device (7) in order to adapt the width of these passages to the dimensions of said products, and also comprising means for longitudinally adjusting the space between the consecutive rows of stops (13) which move along with the products.

### FIELD OF THE INVENTION

The present invention relates to a refinement to the installations for preparing batches of products of bottle or similar kind, in order, for example, to place them in crates or in order for them to be packaged by means of a cladding with a plastic film of heat-shrinkable material.

### DESCRIPTION OF THE PRIOR ART

Packaging, pallet-wrapping and similar machines are fed from a flow of products which is worked to prepare batches into which said products are divided up according to a given scheme.

The document WO 98/45186, for example, shows an installation which makes it possible to prepare batches of bottles from a flow of products which is divided up into a number of lines and the products are then organized in groups, by means of a system of fingers which are inserted between the products of each line. This kind of installation is appropriate for mass productions; it is not designed to be adapted easily to batch schemes which can vary depending on the destination and, above all, depending on the dimension of the products.

The document U.S. Pat. No. 5,667,055 shows an installation for preparing batches of bottles or similar products which comprises a feed conveyor, an unbundling conveyor consisting of a number of endless belts associated with a system of retaining stops which are supported by cross-members, which cross-members are spaced apart by a distance which corresponds to the diameter of the bottles to form a row of bottles between two consecutive cross-members, which stops have a speed of advance which is less than that of the unbundling belts to automatically create a separation between two rows of bottles at the moment of retraction of said retaining stops, which rows are each taken over, after the retraction of said stops, by a bar of an orbital conveying device which leads each row of bottles to a downstream accumulation conveyor.

In this document, the downstream accumulation conveyor advances at a speed which makes it possible to group together rows of bottles in cooperation with the orbital conveying device which consists of two conveyors with bars that are nested and of different lengths, which bar conveyors act together to take over each row of bottles on the unbundling conveyor and to transfer them to the downstream accumulation conveyor, and, then, the conveyor with bars of the greatest length performs the grouping-together of three rows on said downstream conveyor, according to the embodiment represented in the figures.

The unbundling is performed simultaneously with the retraction of the fingers by virtue of the speed difference between the speed of the unbundling conveyor and the speed of the stops. The unbundling accuracy therefore depends mainly on the accuracy of the delivery of the bottles by the stops; as it happens, at the moment of the delivery of bottles, the contact between the stops and the bottles may generate offsets in one and the same row of bottles.

This type of highly specialized installation has no flexibility, that is to say, it cannot process batches of bottles of different diameters. In practice, a change of diameter of the bottles imposes a change of pitch between the multitude of stops.

The installation according to the invention makes it possible to deal with products of varying dimensions and shapes, but always with circular or oval sections; it makes it possible to overcome the constraints associated with the dimensional variations of the products to be grouped together in order to form batches whose dimensions may also vary depending on the product distribution scheme.

This installation is also designed to facilitate interventions of all kinds, maintenance and/or repair, in a minimum of time, in order to avoid disrupting the production of the batches of products.

### SUMMARY OF THE INVENTION

The installation according to the invention, for the preparation of batches of products, comprises, arranged on one and the same frame and in one and the same longitudinal rectilinear direction:
an upstream conveyor which continuously brings said products to be ordered, which products are arranged in columns, or lines, onto this upstream conveyor and they are guided in longitudinal passages,
a downstream conveyor which contributes to fashioning said batches according to a precise scheme, from one or more rows of products,
a device for regulating the flow of products, the chassis of which is arranged between the abovementioned two conveyors, that is to say the upstream conveyor and the downstream conveyor, which regulation device channels the products in passages delimited by lateral walls and a bed and it comprises means for regulating the flow of the products brought by said upstream conveyor by aligning them in the form of transversally rectilinear rows, which means for regulating the flow of products consist of a system of retractable stops which are longitudinally mobile in a continuous manner, which stops are in the form of fingers which are inserted temporarily between the products of one and the same column,
means for adjusting the speed of the various conveyors and of the regulation stops,

and this installation is notably characterized in that said bed of the regulation device consists:
on the one hand, of motorized intermediate conveyors interposed between said upstream conveyor and said downstream conveyor, which intermediate conveyors, of the endless belt type, are framed by the fingers of the regulation stops which circulate between the walls of said passages and the lateral flanges of said intermediate conveyors,
on the other hand, fixed planes arranged at the input and at the output of said regulation device, to form the junction between said upstream conveyor and said intermediate conveyors and between the latter and said downstream conveyor.

Still according to the invention, the installation comprises means for adjusting the width of the passages of the regulation device to adapt the width of these passages to the dimensions of the products and it also comprises means for adjusting, in the longitudinal direction, the space between the consecutive rows of stops which accompany said products.

According to another provision of the invention, the installation includes, at the level of the device for regulating the flow of products, means for automatically centering each intermediate conveyor between the walls of the passage with which it is associated, which means are housed in a support arranged at each end of said intermediate conveyor and these supports are guided transversally on appropriate guideways which are securely attached to the chassis of said regulation device.

Still according to the invention, the means for automatically centering the supports of each intermediate conveyor, between the walls of its own passage, are formed by a pair of pushers with synchronized movements, which pushers, in the form of wedges, are guided perpendicularly to the corresponding walls of the passages, in mobile jaws, which jaws are stressed elastically in order to tend to separate, permanently and synchronously, said pushers towards said walls.

According to another provision of the invention, the jaws of the automatic centering means are housed in each support, each support appearing in the form of a flat U, and said jaws are guided by the central branch, on the bottom of said U, and by an axis stretched vertically between the two parallel branches of said U, which central branch is in turn designed to slide on the transversal guideways borne by the chassis of the regulation device.

Still according to the invention, the intermediate conveyors are associated with their support by means of a simple centering and positioning pin which is situated protruding on the upper branch of the U-shaped support, which intermediate conveyors include a drive pulley which cooperates with a common driving component and, in particular, a transversal shaft with polygonal cross section on which said pulleys of the different conveyors can slide when the width of the passages is being adjusted.

According to another provision of the invention, the walls of the passages of the regulation device, apart from the central wall which is fixed and securely attached to the chassis of said regulation device, are mobile and operate by pairs of walls arranged symmetrically relative to said central wall, and each pair of walls is operated by screw-nut systems, one of which is arranged at the input and the other at the output of said regulation device, with nuts which are securely attached to said mobile walls, at their ends, and screws which are arranged transversally under the level of the bed forming the product-conveying plane, so as to provide a strong rigidity and above all a maximum accuracy for the positioning of said walls and, consequently, a high accuracy for the regulation stops which accompany said products.

Still according to the invention, the screw-nut systems for positioning and adjusting each pair of walls are maneuvered simultaneously by means, for example, of a control system consisting of toothed wheels which are securely attached to the screws of one and the same pair of walls, and toothed belts stretched between said toothed wheels.

According to another provision of the invention, the installation comprises stops for regulating the flow of products which are distributed on cross-members, which cross-members, of which there are four, are divided up into two sets of independent and interlaced pairs, and each pair consists of cross-members which are diametrically opposite, and they are fixed at their ends to driving means in the form of endless chains which are stretched between two pairs of sets of motorized toothed wheels and the motors of these toothed wheels are actuated via means of the numerical control program type, which program is designed to establish, on the one hand, an adjustment of the speed of advance of said stops in order to synchronize their movement with that of the flow of the products when they are introduced between two consecutive products, then, when they are retracted and, to establish, on the other hand, between said pairs of cross-members, a phase difference which makes it possible, according to the dimensions of the products, to adapt the separation between two consecutive cross-members of stops and make this separation correspond to a multiple of the diameter of the products.

Still according to the invention, the cross-members which support the stops for regulating the flow of products are guided by means of a cam system to make it possible to vertically position these stops, parallel to the axis of said products, on the one hand, when said stops are inserted between two consecutive products, at the input of the regulation device and, on the other hand, when the same stops are retracted, at the output of this regulation device.

### BRIEF DESCRIPTION OF THE DRAWINGS

To be able to be executed, the invention is explained sufficiently clearly and comprehensively in the following description which, in addition, is accompanied by drawings in which:

FIG. 1 is a schematic elevation of the installation according to the invention,

FIG. 2 shows, in perspective, the regulation device, in module or cassette form, which makes it possible to organize rows of products of bottle type,

FIG. 3 shows the frame of the installation, which frame is designed in cradle form to place the cassette between the upstream conveyor and the down-stream conveyor,

FIG. 4 is an elevation, in the form of a functional diagram, showing the main elements of the installation, and in particular the device for regulating the flow of bottles,

FIG. 5 shows an intermediate conveyor on which are arranged bottles, which bottles are guided in a passage portion and they are retained, at their sides, by the fingers of the stops which make it possible to regulate the speed of the flow of bottles,

FIG. 6 shows, on a larger scale, an embodiment of a regulation stop,

FIG. 7 corresponds to a plain version of FIG. 4 showing, notably, the arrangement of a wall of the passage of the regulation device,

FIGS. 8 to 10 represent the screw-nut system which makes it possible to position and adjust the various pairs of walls which are arranged symmetrically either side of the central wall which is fixed;

FIG. 11 shows, in perspective, a cross-member supporting regulation stops,

FIG. 12 corresponds to a plain version of FIG. 4 showing, notably, the drawing of the guide cam for the various cross-members supporting regulation stops,

FIG. 13 shows, schematically, a side view of a cross-member supporting regulation stops,

FIG. 14 shows the arrangement of the regulation device and also shows a central wall and the shafts of the system for guiding and controlling the cross-members supporting the regulation stops,

FIG. 15 shows the arrangement of the driving system for the regulation stops with the cross-members supporting said stops and the installation of these cross-members on endless chains arranged laterally at each end of each pair of cross-members,

FIG. 16 shows an intermediate conveyor, placed on its end supports,

FIG. 17 shows the regulation device, in module or cassette form, equipped simply with a single inter-mediate conveyor,

FIG. 18 represents one of the intermediate conveyor supports, which support makes it possible to automatically center this conveyor between two walls forming a passage and this support is represented, in this figure, in a position which corresponds to the minimum passage width,

FIG. 19 represents the support of FIG. 18, but in a configuration which makes it possible to center an intermediate conveyor in a passage whose width is at the maximum of its value.

### DETAILED DESCRIPTION OF THE INVENTION

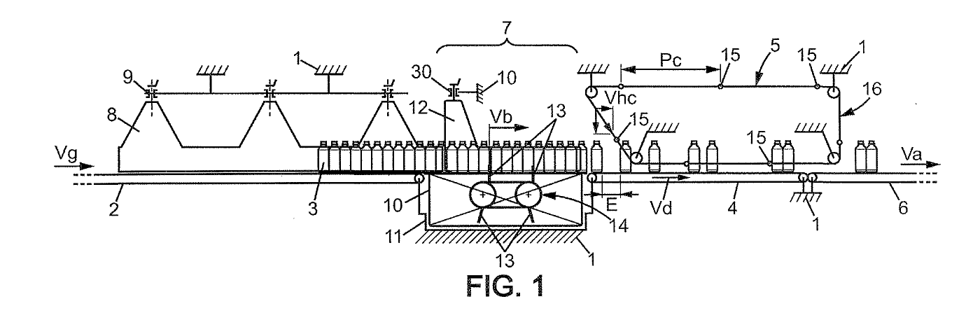

The installation, as represented in FIG. 1, makes it possible to process a flow of products between two machines, not represented, such as, for example, a labeling machine and a stretch-wrapping machine.

This installation comprises a frame 1 on which are assembled:
an upstream endless belt feed conveyor 2 which transports, continuously and at a speed Vg, a flow of products and, more particularly, as represented in FIG. 1, bottles 3;
a downstream endless belt conveyor 4 which performs an unbundling of the bottles 3 and this conveyor 4 advances at a speed Vd;
a device for forming batches of bottles 3, called cycler 5, which will be detailed below, which cycler 5 is arranged above said downstream conveyor 4;
a final conveyor 6, with endless belt, which feeds, for example, a pallet-wrapping machine, not represented, at a speed Va which is related to the speed Vg of the feed conveyor, and,
between the upstream conveyor 2 and the downstream conveyor 4, a conveying and regulation device 7 which places the bottles 3 in the form of ordered rows, that is to say, rows that are perfectly rectilinear in a transversal line perpendicular to the longitudinal direction of movement of said bottles 3 on said installation.

The bottles 3 are brought by the upstream conveyor 2, and they are arranged in columns, or lines, guided in the longitudinal passages formed by the vertical walls 8 which are supported by cross-members 9.

The bottles 3 are pushed continuously and permanently by the upstream conveyor 2 which serves as a feed conveyor. This upstream conveyor 2 pushes the bottles 3 over the regulation device 7 to keep them grouped together, in contact with one another, in order to avoid the formation of voids between the consecutive bottles of one and the same column.

The regulation device 7 comprises its own chassis and it appears in the form of an interchangeable module, or cassette, which is housed in a kind of cradle 11 formed in the frame 1 between the upstream conveyor 2 and the downstream conveyor 4 with continuity at the level of the conveying plane of the bottles 3.

On the regulation device 7, the bottles 3 are also guided in passages formed by walls 12 which extend over the length of this regulation device 7, which walls 12 are in extension of the walls 8 of the upstream conveyor 2.

This regulation device 7 also serves as a conveyor, but in a particular way. In fact, it includes stops 13 installed on the driving system 14 and these stops 13 are mobile to accompany the bottles 3 in their respective passages.

The driving system 14 for the stops 13 comprises cross-members which support the latter, which cross-members are themselves borne and driven by endless chains stretched between toothed wheels; this driving system 14 for the stops 13 will be detailed later in the description.

The stops 13 bar the passage of the bottles 3 in the passages of the regulation device 7 and these bottles are obliged to advance at the speed Vb of said stops, which speed Vb is slightly lower than the speed Vg of the upstream conveyor 2 which is responsible for feeding the installation with bottles and in particular for feeding this regulation device 7 which controls the speed of the flow of bottles. The speed Vg of the feed conveyor 2 is greater than that of the stops 13 by a value of the order of ten percent.

The production of rows of bottles tight against one another, by virtue of the stops 13, makes it possible, at the output of the regulation device 7, to produce a precise separation of said rows of bottles from one another by means of the downstream conveyor 4 which serves as unbundling conveyor.

The speed Vd of this downstream unbundling conveyor 4 is greater than the speed Vb of the stops 13 in order to separate the rows of bottles at the output of the regulation device 7 and establish, between two consecutive rows, a space E, which space is necessary to then proceed with the unbundling of said rows in order for batches of bottles to be formed by means of the cycler 5.

This cycler 5 comprises bars 15 which are borne by two endless chains 16 on which said bars 15 are regularly spaced. These bars 15 are inserted between the rows of bottles, at the output of the regulation device 7, and their function is to group together, depending on the case, a number of rows of bottles to form a batch conforming to the planned scheme.

To perform this grouping together, each bar 15 is inserted from top to bottom between two consecutive rows of bottles 3, following an inclined path. Each bar 15 is inserted into the space E which separates the two rows of bottles 3, at a speed whose horizontal component Vhc is equal to the speed Vd of advance of the downstream unbundling conveyor 4 and, then, said bar 15 advances at a speed Vc which is greater than the speed Vd of said downstream conveyor 4 in order to perform, on the latter, a possible realignment of the row and, depending on the case, in addition, a grouping together of the various rows which are situated between two consecutive bars 15 of the cycler 5.

This grouping together is performed by pushing, with the corresponding bar 15, the last row of bottles so as to gather together this last row with the preceding row or rows and form the planned batch. The speed Vc of advance of the bars 15 above the belt of the downstream conveyor 4 is greater than the speed Vd of the latter, so the row taken over by the bar 15 returns to said belt and catches up on the preceding rows which advance at the speed Vd of said conveyor 4.

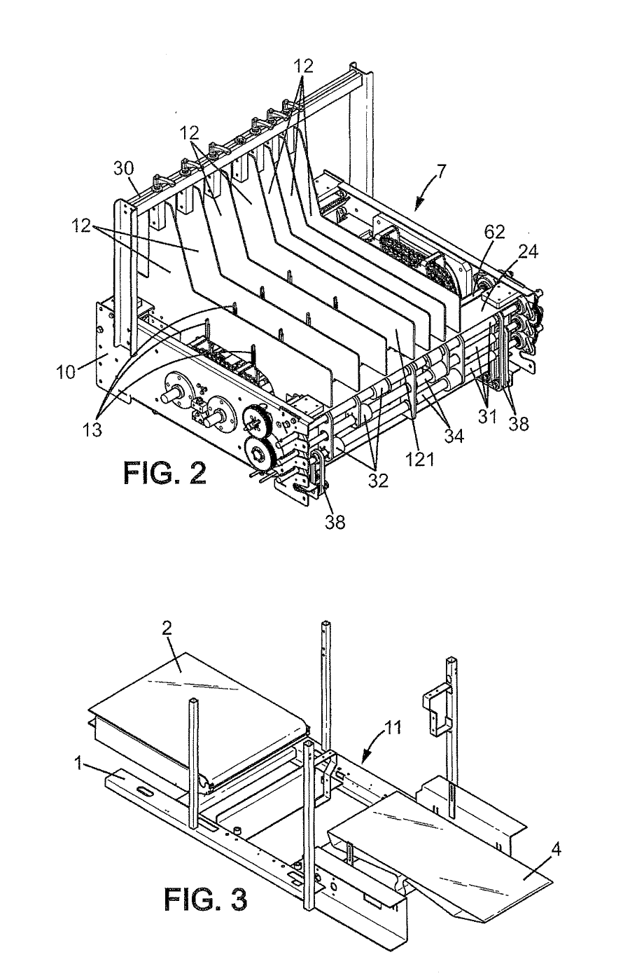

FIG. 2 shows the regulation device 7 with, gathered together on the chassis 10, the various walls 12 which constitute the passageways for the bottles 3.

In this figure, the walls 12 are represented with two types of spacing: —on one side of the central wall 121, the walls are represented in a small passage width configuration and, —on the other side, they are represented in a wide passage width configuration. In reality, the walls 12 are arranged symmetrically relative to the central wall 121; they operate in pairs to move apart or toward one another together.

Still in this FIG. 2, the presence of means of adjusting the position of the walls 12 to adapt the width of the passages to the dimension of the bottles 3 will also be noted; these adjustment means will be detailed later.

Also to be noted, in this FIG. 2, are the stops 13, in the form of fingers, which accompany the bottles 3 in their passage in the regulation device 7.

These stops 13 of the regulation device 7 are used, as indicated previously, to impose a speed of advance on the flow of bottles 3 and to position these bottles in rows by aligning them transversally in a perfectly rectilinear manner. These stops 13 accompany the bottles 3 which are pushed permanently by the upstream conveyor 2; the bottles slide on this conveyor 2 because of the speed difference between said stops 13 and said conveyor 2 which feeds the regulation device 7.

The tight rows of bottles 3, which are formed by virtue of the stops 13, are maintained as far as the input of the downstream conveyor 4 which serves as unbundling conveyor, which means that the function of this downstream conveyor 4 is to separate one by one the rows of bottles that are ordered by said stops 13.

All this be detailed later in the description.

FIG. 3 shows the frame 1 which is provided to accommodate the regulation device 7. This frame 1 includes the cradle 11, between the upstream conveyor 2 and the downstream conveyor 4, to accommodate the regulation device 7 and position it in order to ensure continuity at the level of the conveying plane of the bottles over the length of the installation.

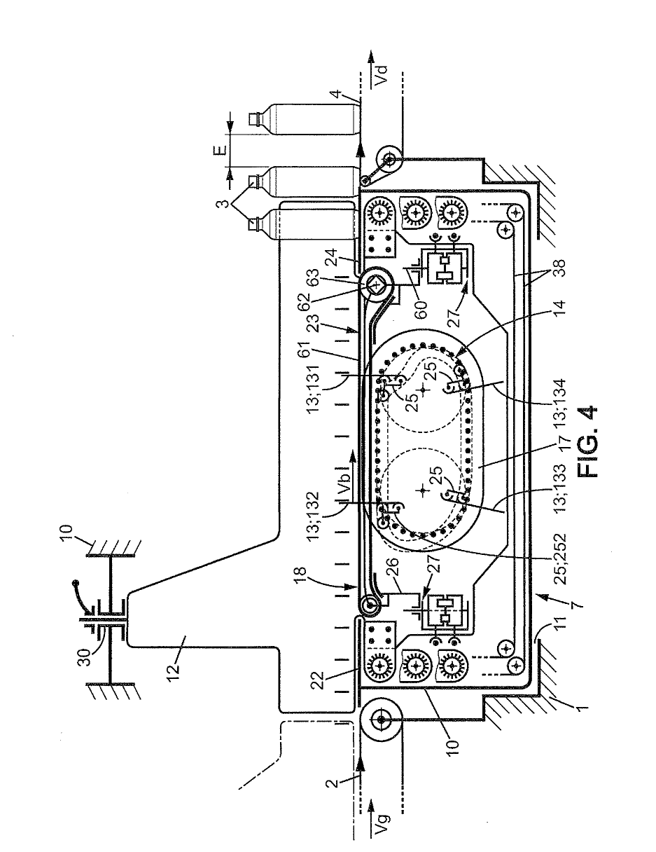

FIG. 4 shows, in the form of a diagram, the part of this installation which is situated between the upstream conveyor 2 and the downstream conveyor 4, that is to say, the device 7 for regulating the flow of bottles 3.

This regulation device 7 therefore comprises the chassis 10 which is positioned in the cradle 11 of the frame 1. This chassis 10 is in the form of a module, or cassette, which constitutes a kind of equipment item for the installation, and in particular an interchangeable equipment item.

This regulation device 7 comprises walls 12 which form the various guide passages for the bottles 3 and an oblong orifice 17 can be seen, provided at the core of each wall 12; this orifice 17 is situated under the level of the bed 18 which constitutes the conveying plane for said bottles 3. This orifice 17 frames the driving system 14 for the stops 13 which will be dealt with later.

The bed 18 of the regulation device 7 consists of a number of abutting elements: two fixed planes 22 and borne directly by the chassis 10 and a number of intermediate conveyors 23 of the endless belt type. A first fixed plane 22 is situated at the input of the regulation device 7, and it forms the junction between the upstream conveyor 2 and the intermediate conveyors 23 which are inserted between the walls 12. The second fixed plane 24 forms the junction between the intermediate conveyors 23 and the downstream conveyor 4.

The bottles 3 follow a horizontal rectilinear path from the upstream conveyor 2 to the downstream conveyor 4, passing in succession over the fixed plane 22 situated at the input of the regulation device 7, then over the various intermediate conveyors 23 and, finally, over the fixed plane 24 before reaching the downstream conveyor 4.

The bottles 3 are channeled on the regulation device 7, between the walls 12 which form passages, which walls 12 are situated in the extension for walls 8 which are arranged above the upstream conveyor 2.

The bottles 3 are moved in columns, or rows, at a speed Vg on the upstream conveyor 2, which speed is chosen to perform a kind of feeding of the regulation device 7.

On this regulation device 7, the bottles 3 have a speed Vb which is set by the stops 13, which stops, as detailed later, are arranged on rectilinear cross-members 25 which are longitudinally mobile to accompany, while retaining them, the bottles 3 of the various columns, or lines, thus forming rows of bottles that are perfectly rectilinear, transversally, and compact, because of the thrust originating from the bottles 3 situated upstream on the upstream conveyor 2.

In fact, these stops 13 retain the bottles which are brought and pushed by the upstream feed conveyor 2. These stops 13 form the equivalent of a barrier that is both real and virtual; this barrier is real in that it stops the bottles 3 that are brought by the upstream feed conveyor 2, but it is also virtual in that the row of bottles which is downstream of this barrier, is in direct contact with said bottles which are stopped by said barrier; also, these bottles which are downstream are still pushed by the bottles that are retained and that are aligned on said stops 13; these downstream bottles are not pushed by the stops 13, said stops simply accompany the movement of the downstream bottles.

By virtue of the management of the speed of the feed conveyor 2 and the management of the speed of the barrier consisting of the stops 13, the advancing of the rows of bottles 3 is perfectly controlled so that the rows are perfectly ordered and offer a maximum of safety for the correct procedure of the subsequent unbundling operation which will consist in separating, one after the other, the rows that appear on the downstream conveyor 4 whose belt circulates at a speed Vd greater than the speed Vb of said stops 13.

The main function of the upstream conveyor 2, as indicated previously, is to feed the regulation device 7, to avoid the formation of voids in the columns of bottles 3 and to maintain a certain compactness at the level of each column of bottles 3.

Still in FIG. 4, the four sets of regulation stops 13 can be seen; two consecutive sets of these four sets of stops are in an active position, inserted between consecutive bottles 3.

As the bottles 3 advance, there is always at least one set of stops 13 in an active position retaining the bottles 3 in their passages and, at the most, there can be only two sets of consecutive stops 13 in the active position.

When a set of stops 13 is introduced between two consecutive bottles 3, in front of the regulation device 7, just one set of stops 13 is in the active position because the preceding set of stops 13 is already retracted under the level of the plane of circulation of said bottles.

Means detailed later and, in particular, a cam associated with the motorization mechanism of the stops 13, enable the introduction and the retraction of said stops by placing them and maintaining them in a position which is perpendicular to the plane of displacement of the bottles 3, parallel to the axis of said bottles.

Each intermediate conveyor 23 comprises a structure 26 which rests, at each of its ends, on a support 27 which will be detailed later, which support is itself supported by guideway which make it possible, as detailed later also, to displace each intermediate conveyor 23 transversally according to the position of the walls 12 which form the passages and do so each time the width of said passages is adjusted, when there is a change of format at the bottle level.

The speed Vi of the intermediate conveyors 23 is of the same order as the speed Vb of the stops 13, but slightly less, to maintain a contact between said stops 13 and the bottles 3, which contact depends, because of this, on the pressure exerted by the bottles which are supported by the feed conveyor 2 and which are situated upstream of said stops 13.

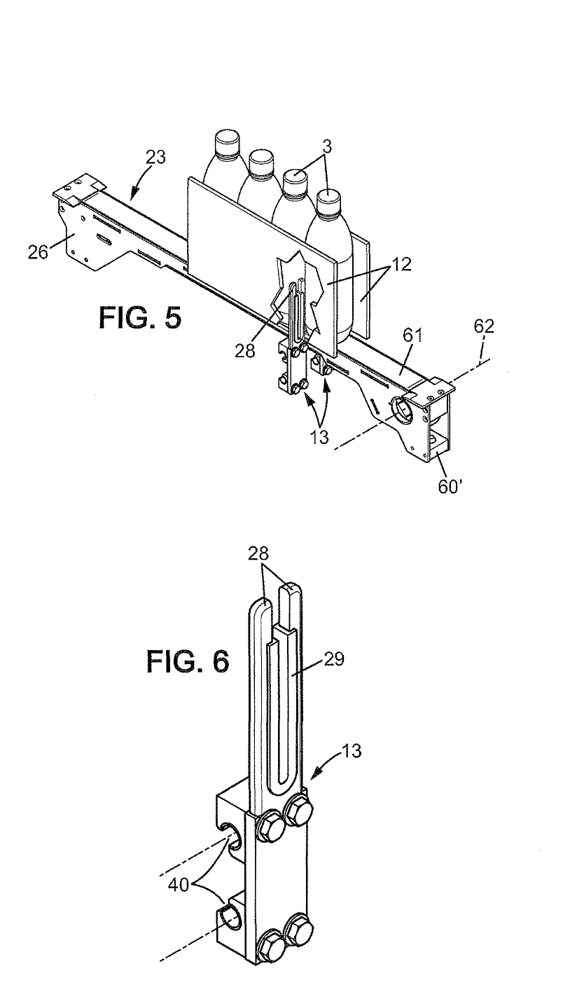

FIG. 5 shows a few bottles 3 arranged in line on an intermediate conveyor 23, which bottles are guided by the walls 12 which form a passage in which said conveyor 23 is centered. In this passage, the bottles 3 bear on the fingers of the stops 13 which accompany the movement of said bottles at a speed Vb which is substantially less than the speed Vg of the upstream conveyor 2.

It will be noted, in FIG. 6, that the stops 13 take the form of a tuning fork with two fingers 28; these fingers 28, of one and the same stop 13, frame the wall 12 with which they are associated, as shown in FIG. 5 and the fingers 28 situated in one and the same passage frame the conveyor 23 which constitutes the bed 18 of this passage.

Preferably, each stop 13 includes a skid 29, made of an appropriate material of the antifriction kind, which skid, in the form of a U, is interposed between the fingers 28 and the wall 12 concerned to avoid excessive friction between the two.

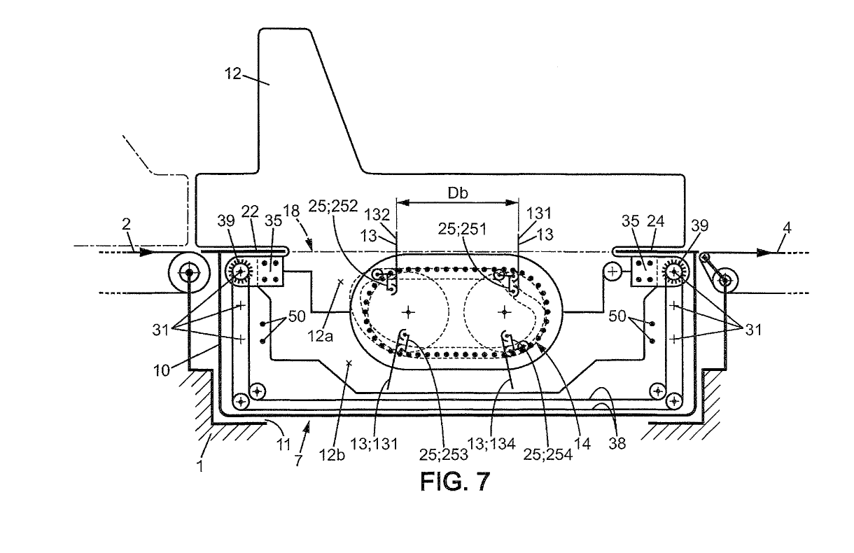

The walls 12 extend above the bed 18 which forms the conveying plane of the bottles 3 on the regulation device 7, and they extend, as can be seen clearly in FIG. 7, below this bed 18. These walls 12 are positioned and adjusted to establish the width of the passages by means of a number of screw-nut type systems which are arranged at the input and at the output of the regulation device 7.

In their upper part, these walls 12 are fixed to a beam 30 which is securely attached to the chassis 10. This beam 30, which can be seen in FIGS. 1, 2 and 4, in particular, is arranged transversally and it is provided with means, of the guideway type, that allow the displacement of the walls 12, transversally, in the width of the various passages in which the bottles 3 circulate is adjusted.

Similarly, the walls 8, as shown in FIG. 1, are fixed to the beams 9 which are securely attached to the frame 1 and these beams 9 are also designed to allow the transversal position of said walls 8 to be adjusted.

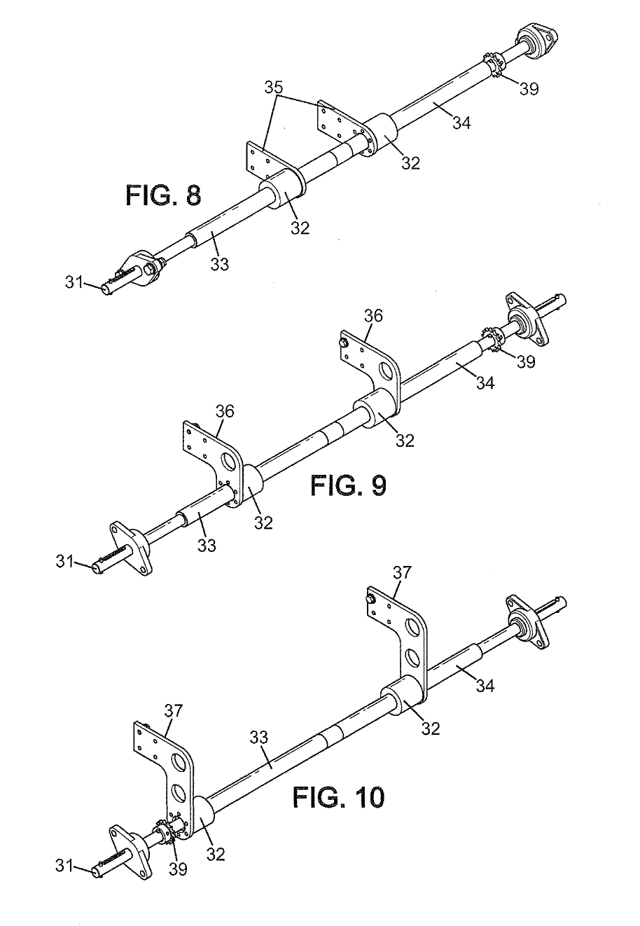

FIGS. 8 to 10 show the various screw-nut systems that can be used to adjust the position of the pairs of walls 12, and in particular of the three pairs of walls which are situated on either side of the central wall 121, which central wall 121 is fixed, securely attached to the chassis 10, as mentioned previously in relation to FIG. 2.

These various pairs of walls 12 are guided and controlled, at each of their ends, by means of shafts 31 which extend under the level of the bed 18 and these shafts 31 are mounted in bearings securely attached to the sides of the chassis 10.

Each mobile wall 12 is in fact securely attached to a nut 32 which is mounted on the corresponding shaft 31; it is securely attached to said nut 32 via a tab, detailed hereinbelow, the shape of which is adapted to the position of said corresponding shaft 31 and this tab, including said nut, is also used to join the two constituent parts of each wall 12.

In practice, these walls 12 include, under the level of the bed 18, an oblong orifice 17 to allow for the passage of the driving system 14 for the stops 13 and, for reasons of ease of mounting of this driving system, they are produced in two parts: an upper portion 12a and a lower portion 12b, which portions 12a and 12b are assembled by tabs which form part of the means of adjusting the separation of said walls 12.

FIG. 8 shows the screw-nut system for the pair of walls 12 which form the two central passages in cooperation with the central wall 121 which is fixed. This screw-nut system is situated as close as possible to the bed 18 for guiding the bottles 3, under the latter.

Two screws 33 and 34, with reversed pitch, are machined on one and the same shaft 31, on either side of the central part of said shaft. These threaded parts of the shaft 31 are situated on each side of the central wall 121, and two nuts 32 cooperate respectively with these two screws 33 and 34 to drive the tabs 35 to which the corresponding walls 12 are fixed, which tabs 35 are also used to link the two portions 12a and 12b which form these walls 12.

FIGS. 9 and 10 show the screw-nut systems which are situated under the screw-nut system described previously. These two screw-nut systems comprise, as previously, screws 33 and 34 with reversed pitches which extend on either side of the median part of the shaft 31 and nuts 32 which are securely attached to the tabs 36 and 37 in bracket form, which tabs 36 and 37 are securely attached, respectively, to the two other pairs of walls 12, as also shown in FIG. 2. The horizontal branch of the brackets 36, 37 acts as a member for assembling the two parts 12a and 12b of the walls 12 and the vertical part of these brackets 36, 37 is securely attached to the nuts 32 which handle the displacement of said walls 12 in cooperation with the screws 33 and 34. The various horizontal branches of the brackets 36, 37 are situated at the same level as the tabs 35, that is to say just under the level of the bed 18, and the vertical branches have a length which is adapted to the position of the screws 33 and 34; these vertical branches extend under the level of the bed 18.

The width of the passage is adjusted by displacing each pair of walls 12, symmetrically, on either side of the central wall 121. This displacement of the various pairs of walls 12 is done one pair at a time manually or by means of a suitable motorization system by acting on the shafts 31 which support the screw 33, 34.

As represented in FIG. 2 and FIG. 7, the screw-nut systems of one and the same pair of walls 12 are linked via a transmission of the belt 38 type, which belt 38 is stretched between toothed wheels 39 which are arranged at the end of the corresponding shafts 31 which are situated at the input and at the output of the regulation device 7.

This type of mounting gives the walls 12 a great rigidity at the level of the bed 18, that is to say, at the level of the plane of circulation of the bottles 3 and, consequently, a more precise positioning of the fingers 28 relative to the bottles themselves.

In practice, the fingers 28 are each in contact with a generatrix of the bottles 3, and the precision of this finger-bottle contact has to be as precise as possible to obtain perfectly ordered rows of bottles; each bottle 3 of one and the same row must be placed in a plane which is perpendicular to the longitudinal axis of advance of said rows.

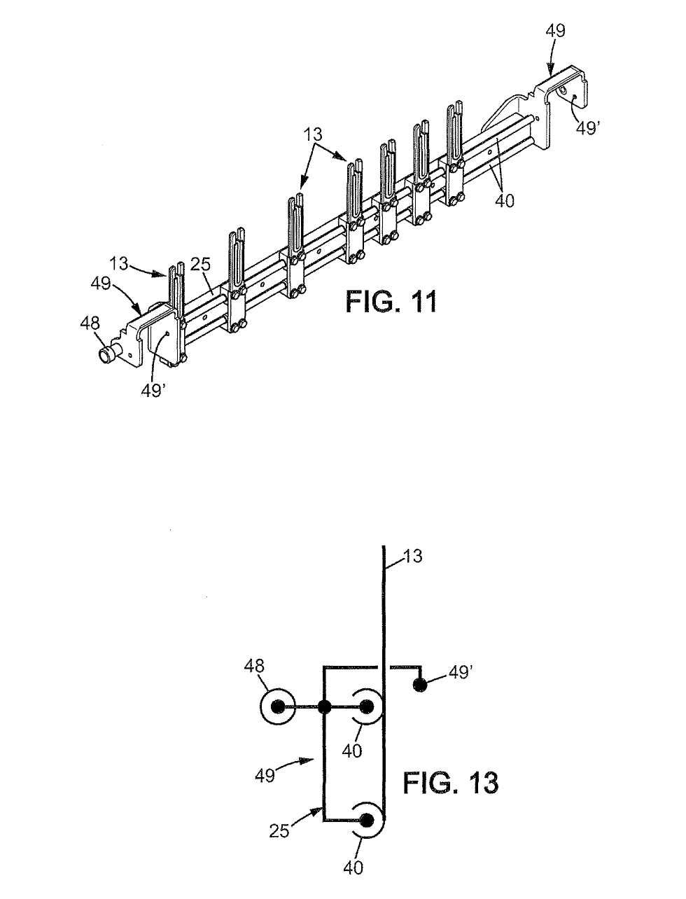

FIG. 11 also shows that the stops 13 are mobile transversally; they are mounted on guideways 40 which are installed on each cross-member 25 to follow the walls 12 and be automatically adapted to the position of said walls when their separation is adjusted.

The cross-members 25 are supported, at their ends, by endless chains which are wound on a pair of toothed wheels: a first set of pair of toothed wheels supports two cross-members and a second set of pair of toothed wheels supports the other two cross-members.

FIG. 7 shows the position of the four cross-members 25: the cross-members 251 and 253 are securely attached to the endless chains of one and the same set of pair of toothed wheels and the cross-members 252 and 254 are, similarly, securely attached to endless chains of another set of pair of toothed wheels.

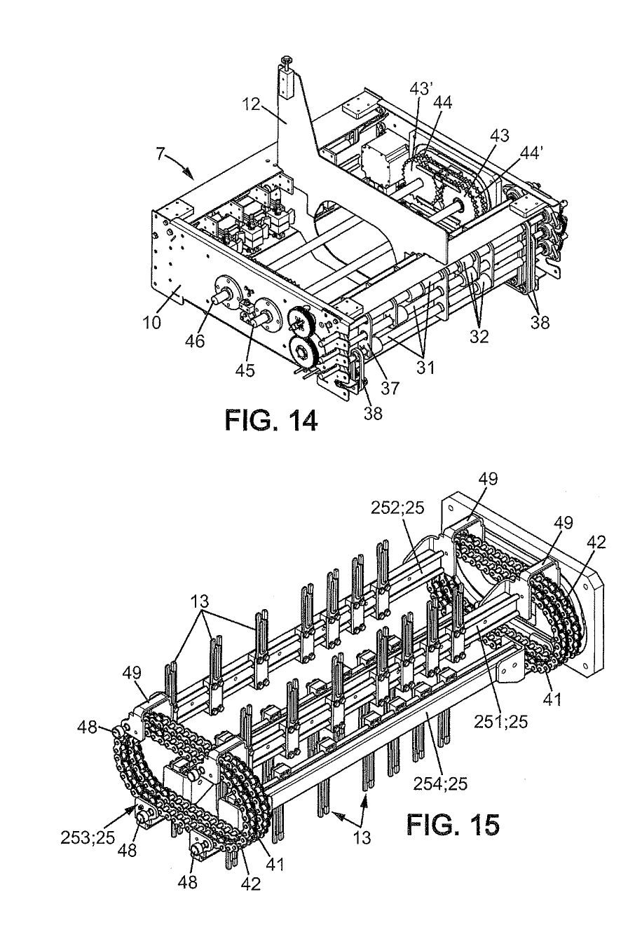

These pairs of toothed wheels appear in particular in FIG. 7 in dotted lines and FIG. 14, and the endless chains also appear in FIG. 15.

Each pair of cross-members 25 is supported, at its ends, by two endless chains: the pair of cross-members 251, 253 is supported by the pair of chains 41 and the pair of cross-members 252, 254 is supported by the pair of chains 42.

Each chain 41 is wound on two toothed wheels 43, 43′, and, similarly, each chain 42 is wound on two toothed wheels 44, 44′.

The cross-members 251 to 254 support the stops 13 and these stops 13 have been marked in FIG. 7, respectively, with the identifiers 131 to 134.

The cross-members 251 and 253 form a pair and they are diametrically opposite one another relative to the median point which is situated midway between the axes of the wheels 43, 44. Similarly, the cross members 252 and 254 are diametrically opposite relative to this median point which is situated midway between the axes of the wheels 43, 44.

The toothed wheels 43 of each chain 41, are driven by one and the same drive shaft 45 and the toothed wheels 44 of each chain 42 are driven by one and the same drive shaft 46. The two drive shafts 45 and 46 have a center-to-center distance which is substantially greater than the diameter of the toothed wheels and they also act as a simple bearing for the other toothed wheels 44′ and 43′ respectively.

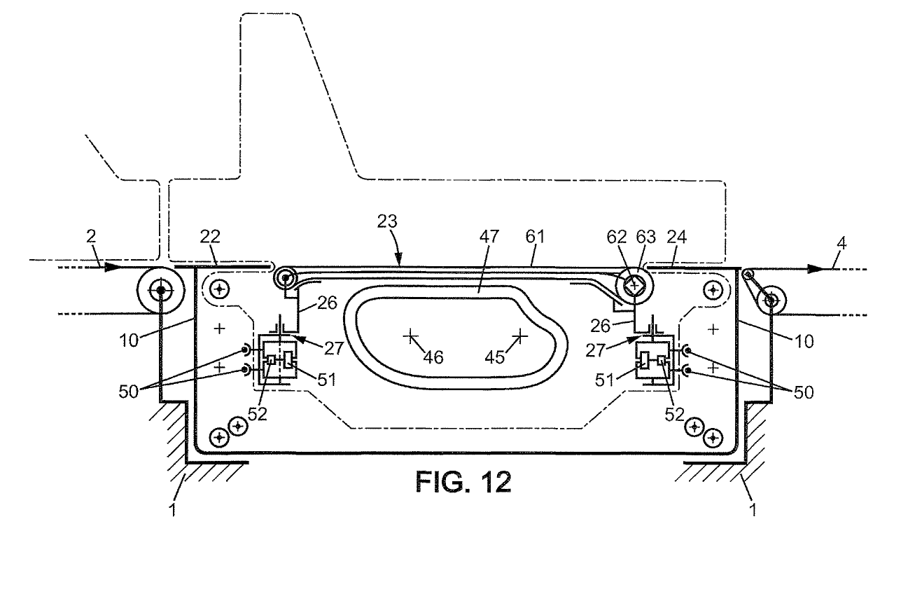

For them to be able to be easily inserted between two consecutive bottles 3, the stops 13 are oriented by means of a system of cams and following rollers. Two identical cams 47 are installed on the lateral walls of the chassis 11 and one of them can be seen in FIG. 12 in particular. These cams 47 cooperate with following rollers 48 which can be seen in FIGS. 11 and 15, positioned at each end of the cross-members 25. These rollers 48 are securely attached to the cross-members via U-shaped pieces 49, one leg of which is fixed to the end of the corresponding cross-member 25, and the other leg of which supports the roller 48. These pieces 49 make it possible to fix the pairs of cross-members 25 to each pair of endless chains and they also allow for an overlap of the pair of endless chains and, in particular, the endless chains supporting the other pair of cross-members.

FIG. 13 schematically represents a cross-member 25 with its guideways 40 to support the stops 13. This cross-member 25 also supports, at each of its ends, a roller 48 which is mounted on the U-shaped piece to cooperate with the cam 47. This U-shaped piece also includes means that make it possible to fix each cross-member 25 to the corresponding endless chains 41 and 42. The means of fixing the cross-members 25 to the chains 41 and 42 consist of an axis 49′ which makes it possible, for each cross-member 25, to retain a partial tilt freedom to follow the movement of the roller 48 with which said cross-member 25 is associated, which movement being imposed by the path of the cam 47.

Because of the dimensional variations of the bottles 3, it is also necessary to vary the distance Db between two consecutive stops 13 which penetrate the columns of these bottles 3, in a passage of the regulation device 7.

The distance Db between two consecutive stops 13 is also n times the diameter of the bottles, in which n is at least equal to two; in fact, Dd has a value which is of the order of 240 mm. This value of Dd, combined with the possibility of slightly varying this distance Dd, makes it possible to manage a flow of bottles (3) that are commonly used whose diameters may range from to 120 mm. In practice, it is possible to house, between two consecutive stops 13:
five bottles of 55 mm diameter, or Dd=275 mm,
four bottles of 66 mm diameter, or Dd=264 mm,
three bottles of 88 mm diameter, or Dd=264 mm,
two bottles of 120 mm diameter, or Dd=240 mm.

This variation of the distance Db to be managed is therefore of the order of 35 mm, for example. The management of the separation between the successive stops 13 is made possible by an appropriate control of each of the motors driving the two sets of pairs of toothed wheels.

The motors of the toothed wheels 43 and 44, attached to each pair of cross-members 25 of stops 13, are controlled by a logic controller, of the numerical control type, to produce a phase difference in these two pairs of cross-members 25 and to permanently adapt the distance Db between two consecutive stops 13 to the diameter of the bottles.

This numerical control also makes it possible to vary the speed of these stops 13 to allow for them to be introduced between two bottles of one and the same column at the right time and, also, to allow for their removal at the right time without disturbing the column of bottles which is advancing, which column is pushed by the flow of bottles 3 brought by the upstream feed conveyor 2 while being constantly retained by at least one of the sets of stops 13.

This arrangement of the regulation device 7, combined with the downstream unbundling conveyor 4, also makes it possible to form a wide variety of batches of bottles comprising one or more rows. The regulation device 7 presents the rows of bottles 3 to the downstream conveyor 4 and this downstream conveyor 4 performs the unbundling of said rows, one by one, systematically.

In practice, the device 7 for regulating the flow of bottles makes it possible, by means of the adjustment of the speed of advance of the stops 13 and of the speed of the downstream conveyor 4, to introduce, between two consecutive bars 15 of the cycler 5, a greater or lesser number of rows of bottles 3.

The space E between two rows of bottles 3 results from the unbundling and from the difference in the speeds which exists between the stops 13 and the down-stream conveyor 4; this space E is variable and it is chosen according to the number of rows of bottles which are necessary to form a batch. This space E must, in any case, be sufficient to allow for the introduction of the relevant bar 15.

The installation therefore allows for the formation of batches of bottles made up of a variable number of rows of bottles, said number of rows being established by the pitch Pc which exists between two cleats 15 of the cycler 5.

The speed Vg of the upstream feed conveyor 2 is obviously adapted to the speed Vb of the stops 13. Similarly, the speed Vi of the intermediate conveyors 23 is adjusted according to the speed Vb of the stops 13, preferably, as indicated previously, this speed Vi is slightly less than that of said stops.

The regulation device 7 has a multipurpose nature which enables it to be adapted equally to the dimensions of the bottles 3 and to the organization of the batches of bottles.

The positioning of the walls 12 of the regulation device 7 affects the position of the stops 13, as specified previously, but it also affects the position of the intermediate conveyors 23 which must remain centered in their own passage.

Each intermediate conveyor 23 includes, as indicated previously in conjunction with FIG. 4, a structure 26 which serves as a frame, which structure is arranged to guide the endless belt of said conveyor and it is supported, at each of its ends, by supports 27, which supports 27 are mobile transversally by means of guideways 50 which extend transversally in the chassis 10, as represented in FIG. 12 and which are securely attached to this chassis 10.

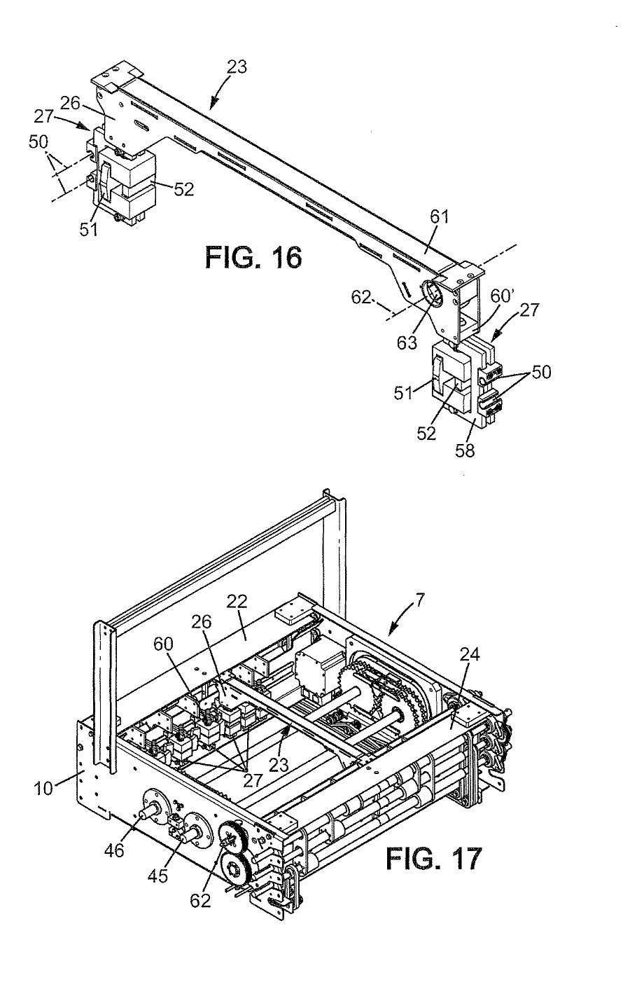

FIG. 16 shows an intermediate conveyor 23 which is placed, at each of its ends, on the supports 27; this conveyor 23 forms a sort of module, which is easy to dismantle and to interchange if necessary.

To perform the centering of these conveyors 23 and their supports 27, between the set of walls 12, said supports 27 are required to accommodate an automatic centering device which is detailed in FIGS. 16 to 19.

This automatic centering device is like a compass; it comprises two pushers 51 and 52 in the form of wedges, arranged transversally, the movements of which are synchronized, and these pushers 51 and 52 are set in motion by the walls 12 with which they are in permanent contact.

These pushers 51 and 52 are guided in a pair of jaws 53 and 54 which are themselves vertically mobile, guided on an axis 55 which extends in the support 27. The jaws 53 and 54 are permanently stressed by elastic members of the spring 56 and 57 type which tend, by reaction, to permanently press the pushers 51 and 52 onto the walls 12. These jaws 53 and 54 include grooves that are arranged opposite to accommodate the pushers and 52 in the form of wedges; which grooves are formed perpendicularly to the walls 12, and they comprise surfaces formed at an angle to cooperate with those of said pushers 51 and 52.

The support 27 is U-shaped, arranged flat, and its central leg 58 is vertical and it is formed in order, on the one hand, to serve as a guiding surface for the pushers 51 and 52, and, on the other hand, on the outside, to cooperate with the guideways 50 which are securely attached to the chassis 10.

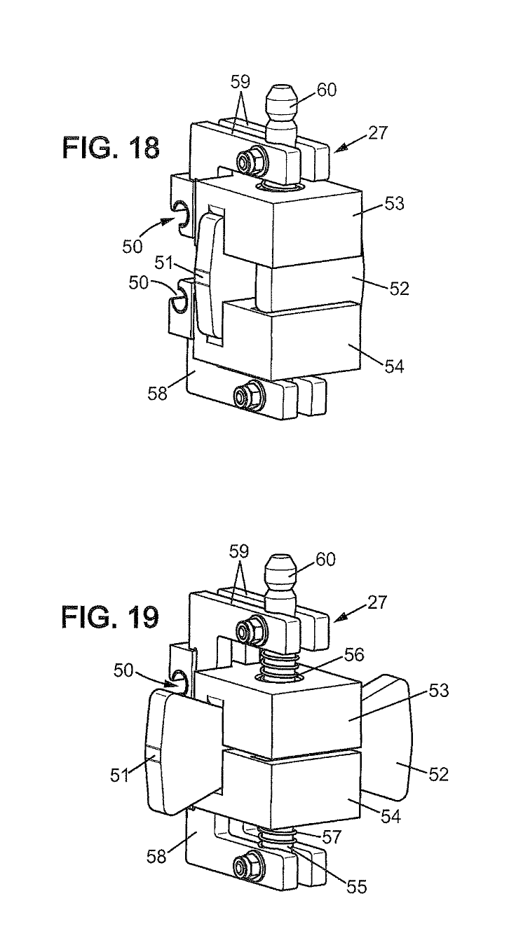

Above the upper leg 59 of the support 27, still in FIG. 18, a pin 60 can be seen which cooperates with a bush 60′ arranged at the bottom end of the structure 26 of the intermediate conveyor 23, as can be seen in FIGS. 5 and 16. This pin 60 protrudes onto the upper leg 59 of the U-shaped support 27; it constitutes an extension of the upper part of the axis 55 which extends between the two branches of said U: the top leg and the bottom leg which serve as guides for the pushers 51 and 52.

Each intermediate conveyor 23 and, in particular, its endless belt 61, is driven by means of a shaft 62 which extends transversally. This shaft 62 preferably has a polygonal cross section, square for example, to drive the toothed wheel 63 on which the belt 61 is wound. The shaft 62 enables the wheel 63 to slide transversally and accompany the support 27 and the conveyor 23 which follow the movement of the walls 12 when they are displaced to adjust the width of the corresponding passage.

The regulation device 7 also preferably takes the form of a module, or cassette, that is to say that it is easily dismantleable to allow for the installation of a variant which may, for example, be adapted to particular products of the vial type. These vials may require retaining means, that is to say stops 13, that have a particular shape.

1.-10. (canceled)

11. An installation for preparing batches of products comprising, arranged on one and the same frame and in one and the same longitudinal rectilinear direction:
an upstream conveyor which continuously brings said products to be ordered, which products are arranged in columns, or lines, onto this conveyor and they are guided in longitudinal passages,
a downstream conveyor which contributes to fashioning said batches according to a precise scheme, from one or more rows of products,
a device for regulating the flow of products, the chassis of which is arranged between the abovementioned two conveyors, which regulation device channels the products in passages delimited by lateral walls and a bed and it comprises means for regulating the flow of the products brought by said upstream conveyor by aligning them in the form of transversally rectilinear rows, which means for regulating the flow of products consist of a system of retractable stops which are longitudinally mobile in a continuous manner, which stops are in the form of fingers which are inserted temporarily between the products of one and the same column,
means for adjusting the speed of the various conveyors and of the regulation stops,
wherein said bed of the regulation device consists:
on the one hand, of motorized intermediate conveyors interposed between the upstream conveyor and the downstream conveyor, which intermediate conveyors, of the endless belt type, are framed by the fingers of the regulation stops which circulate between the walls of said passages and the lateral flanges of said intermediate conveyors,
on the other hand, fixed planes arranged at the input and at the output of said regulation device, to form the junction between said upstream conveyor and said intermediate conveyors and between the latter and said downstream conveyor.

12. Installation for preparing batches of products as claimed in claim 11, wherein it comprises means for adjusting the width of the passages of the regulation device to adapt the width of these passages to the dimensions of the products and it also comprises means for adjusting, in the longitudinal direction, the space between the consecutive rows of stops which accompany said products.

13. The installation for preparing batches of products as claimed in claim 11, wherein it includes, at the level of the device for regulating the flow of products, means for automatically centering each intermediate conveyor between the walls of the passage with which it is associated, which means are housed in a support arranged at each end of said intermediate conveyor and these supports are guided transversally on appropriate guideways which are securely attached to the chassis of said regulation device.

14. Installation for preparing batches of products as claimed in claim 13, wherein the means for automatically centering the supports of each intermediate conveyor, between the walls of its own passage, are formed by a pair of pushers with synchronized movements, which pushers, in the form of wedges, are guided perpendicularly to the corresponding walls of the passages, in mobile jaws, which jaws are stressed elastically in order to tend to separate, permanently and synchronously, said pushers towards said walls.

15. The installation for preparing batches of products as claimed in claim 14, wherein the jaws of the automatic centering means are housed in each support, each support appearing in the form of a flat U, and said jaws are guided by the central branch, on the bottom of said U, and by an axis stretched vertically between the two parallel branches of said U, which central branch is in turn designed to slide on the transversal guideways borne by the chassis of the regulation device.

16. The installation for preparing batches of products as claimed in claim 15, wherein the intermediate conveyors are associated with their support by means of a simple centering and positioning pin which is situated protruding on the upper branch of the U-shaped support, which intermediate conveyors include a drive pulley which cooperates with a common driving component and, in particular, a transversal shaft with polygonal cross section on which said pulleys of the different conveyors can slide when the width of the passages is being adjusted.

17. The installation for preparing batches of products as claimed in claim 12, wherein the walls of the passages of the regulation device, apart from the central wall which is fixed and securely attached to the chassis of said regulation device, are mobile and operate by pairs of walls arranged symmetrically relative to said central wall, each pair of walls being operated by screw-nut systems, one of which is arranged at the input and the other at the output of said regulation device, with nuts which are securely attached to said mobile walls, at their ends, and screws which are arranged transversally under the level of the bed forming the product-conveying plane.

18. The installation for preparing batches of products as claimed in claim 17, wherein the screw-nut systems for positioning and adjusting each pair of walls are maneuvered simultaneously by means, for example, of a control system consisting of toothed wheels which are securely attached to the screws of one and the same pair of walls, and toothed belts stretched between said toothed wheels.

19. The installation for preparing batches of products as claimed in claim 2, wherein it comprises stops for regulating the flow of products which are distributed on cross-members, of which there are four, which cross-members are divided up into two sets of independent and interlaced pairs, and each pair consists of cross-members which are diametrically opposite, and they are fixed at their ends to driving means in the form of endless chains which are stretched between two pairs of sets of motorized toothed wheels and the motors of these toothed wheels are actuated via means of the numerical control program type, which program is designed to establish, on the one hand, an adjustment of the speed of advance of said stops in order to synchronize their movement with that of the flow of the products when they are introduced between two consecutive products and, then, when they are retracted and, on the other hand, to establish, between said pairs of cross-members, a phase difference which makes it possible, according to the dimensions of the products, to adapt the separation between two consecutive cross-members of stops and make this separation correspond to a multiple of the diameter of the products of the bottle type.

20. The installation for preparing batches of products as claimed in claim 19, wherein the cross-members which support the stops for regulating the flow of products are guided by means of a cam system to make it possible, on the one hand, when said stops are inserted between two consecutive products, at the input of the regulation device and, on the other hand, when the same stops are retracted, at the output of the latter, to vertically position these stops, parallel to the axis of said products.
